(19) United States
(12) Patent Application Publication
(10) Pub. No.: US 2009/0169885 A1
(43) Pub. Date: Jul. 2, 2009

(54) Composite Reinforcement Fiber Having Improved Flexural Properties, And Castable Products Including Same, And Methods

(75) Inventor: Nick Carter, Sacramento, CA (US)

Correspondence Address: VALERIE CALLOWAY;CHIEF INTELLECTUAL PROPERTY COUNSEL, POLYMER GROUP, INC., 9335 HARRIS CORNERS PARKWAY SUITE 300, CHARLOTTE, NC, 28269, US

(73) Assignee: POLYMER GROUP, INC., Charlotte, NC (US)

(21) Appl. No.: 12/092,988

(22) PCT Filed: Nov. 13, 2006
(86) PCT No.: PCT/US06/60841

§ 371 Date: Nov. 10, 2008

Related U.S. Application Data
(60) Provisional application No. 60/736,467, filed on Nov. 14, 2005.

(51) Int. Cl. B32B 27/02; B28B 11/16; B29C 47/08; C04B 16/06

(52) U.S. Cl. 428/399; 264/145; 264/151; 524/2

(57) ABSTRACT

Improved fibrous structural reinforcements (16) for castable compositions (14) are provided and methods for making the same. In one implementation, the improved fibrous structural reinforcements rely 16) on an amorphous crystalline component (10), an isotactic crystalline component (12) and profiled terminal ends (20, 22) to improve flexural properties. The isotactic crystalline component (12) provides an initial strength to the fiber (16) and the amorphous crystalline component (10) provides a latent strength once the fiber (16) is subjected to tension and flexural input in the castable construct (14). The profiled terminal ends (20, 22) lock into a cured keyway (301) in the castable construct (14), thereby providing further enhancement to the tensile strength.

### CROSS-REFERENCE TO RELATED APPLICATIONS

This applications claims benefit of priority to U.S. Provisional Application No. 60/763,467, filed Nov. 14, 2005, which is hereby incorporated by reference in its entirety.

### TECHNICAL FIELD

The present invention generally relates to a structural reinforcement fiber for castable mixtures, and more specifically relates to a structural reinforcement fiber with improved flexural strength to deter cracking of castable mixtures, such as cementitious constructs.

### BACKGROUND ART

Uneven curing of castable compositions, such as concrete, typically results in crack development, with subsequent crack propagation leading to faulty concrete. Many proposals have been made to reinforce, strengthen, or otherwise beneficially alter the properties of cementitious mixtures by applying and/or incorporating various types of fibrous components, including asbestos, glass, steel, as well as synthetic polymer fibers to aqueous based concrete mixes prior to the curing of the concrete. The types of polymer fibers in use or proposed for use include those composed of natural and synthetic composition. As is evident in the prior art, individual fibrous components are well known in terms of their performance modifying attributes.

The fibrous components used typically in the practice of reinforcing cementitious mixtures include, specifically, thermoplastic synthetic fibers of finite staple length, such as polypropylene staple fibers. Thermoplastic staple fibers are produced by a well known and economical melt spinning process, in which molten polymer is extruded through a die having a plurality of small openings to produce a tow of continuous thermoplastic filaments of a controlled diameter. The filaments are cooled and drawn or elongated to increase tensile strength. A size or finish is usually applied to the filaments, followed by drying and cutting into the desired length.

More recently, concrete reinforcement fiber has been introduced that have “dog bone” or “barbell”-shaped geometric profiles at the opposite terminal ends of the fiber. This fiber structure can improve the performance of concrete structures, which have been loaded with such reinforcement fibers, under increasing flexural stresses. While improvement in flexural response of concrete constructs can be seen in use of reinforcing fibers having such geometric profiles, such fibers also have drawbacks. For example, crack development and propagation in the reinforced concrete can occur which may be abrupt and unpredictable. Thus, a need remains for a reinforcement fiber suitable for castable mixtures, such as cementitious mixtures, that provide a dynamic response mechanism to increase flexural stress and, upon application of a pulling force, as experienced during crack propagation, will exhibit improved resistance to tensile and sheering induced failures.

### SUMMARY OF THE INVENTION

The present invention is directed to a composite structural reinforcement fiber with improved flexural strength to deter cracking of castable constructs, such as cementitious constructs.

According to the present invention, the composite structural reinforcement fiber includes a polymeric amorphous crystalline component and a polymeric isotactic crystalline component. The differences in physical performance attained from amorphous and isotactic polymer crystalline components of the fiber impart a dynamic performance to the reinforcement fiber. The isotactic crystalline component provides initial strength to the fiber, while the amorphous crystalline component provides latent or secondary strength performance. For example, continued extension of the fiber occurs under tension or flexural input of a fiber-reinforced cementitious construct loaded with the fibers during and/or after curing of the castable construct. The isotactic crystalline component of the fiber is available to initially impart isotactic strength. The tension or flexural inputs experienced by the fiber in the construct during this period, in turn, cause the amorphous crystalline component of the fiber to draw under the influence of the input forces. During such drawing, the amorphous crystalline component becomes isotactic in situ in response to the input forces acting upon it. As and after this in situ transformation of the morphology of the amorphous crystalline component occurs, it imparts increased tensile strength to the fiber and the concrete being reinforced by it, thus contributing a secondary strength performance.

In a further embodiment, the composite structural reinforcement fiber includes profiled terminal ends. The profiled terminal ends may be of various geometries and lock into the cured keyway formed in the concrete matrix. As the reinforcement fiber incorporates a polymeric amorphous crystalline component and a polymeric isotactic crystalline component, upon application of a pulling force exerted by way of crack formation, for example, the fiber exhibits improved resistance to tensile and sheering induced failures. The dynamic performance incorporated in the reinforcement fiber by the dual components allows for improved conformability of the profiled terminal ends to the formed keyway as continued force is applied to the concrete construct. Progressive crystalline alignment of the crystalline components of the fiber that occurs during the in situ conversion of the amorphous crystalline portion while under continual stress results in a secondary, or staged, tensile strength enhancement.

In one embodiment, the isotactic crystalline component extends the entire length of the discrete length reinforcement fiber, acting to capture the initial loading of strain imparted to the concrete structure. The amorphous crystalline component may extend the entire length of the reinforcement fiber as well to act as a malleable profile to the isotactic crystalline component or the amorphous crystalline component may be solely incorporated into both of the profiled terminal ends. Further, the amorphous crystalline component may be incorporated in both of the profiled terminal ends, and extend the complete length of the reinforcement fiber.

In another embodiment, the present invention further includes a method for making a composite structural reinforcement fiber with profiled terminal ends exhibiting improved flexural resistance. In one embodiment a pre-drawn polymeric continuous filament which includes an amorphous crystalline component and an isotactic crystalline component, is unwound from an unwind station and advanced between at least one pair of compression elements. The pair of compression elements compress a segment of the filament to impart a first desired profile to the continuous filament at that segment, and then the filament is subsequently advanced through a cutting mechanism to cut the pre-drawn continuous filament to size, wherein the cut fiber or fibers each includes at least one of the profiled segments at a terminal end or other location along the length of the cut fiber(s)

In one embodiment, the fiber that jointly has isotactic and amorphous crystalline components or regions, and which is subjected to the above-indicated compression treatment, is provided by a differential treatment of a fiber having one or both of the component materials. In a particular embodiment, one means of production of such a fiber would be to produce an isotactic (e.g., greater than 50%, preferably greater than 60% crystallinity) “starter” filament that then receives a “coating” of amorphous resin, wherein this two region filament is subsequently drawn to attain the final relative crystalline levels specified. In an alternative embodiment, a homogenous “starter” filament can be produced at a greater than 50%, preferably greater than 60%, crystallinity, for example, wherein the outer regions of the fiber are subjected to thermal energy so as to selectively reduce the level of crystalline alignment at those locations relative to other fiber locations not subjected to the thermal energy. The composite fibers prepared in the above manners may then be compressed at their terminal ends to shape them as indicated above.

According to a particular embodiment of the present invention, a method for making the composite structural reinforcement fiber may include two or more pairs of compression elements for imparting a desired profile at multiple locations along the length of the fiber, such as at both terminal ends of the fiber. The pair of compression elements may be heated so as to impart a desired profile by simultaneously thermally softening and shaping a segment of the polymeric reinforcement filament. Other fiber shaping techniques also may be used for this purpose, such as ultrasonic shaping elements, and so forth.

In an alternate embodiment, a method for making a composite structural reinforcement fiber is provided that includes the use of one or more Godet-type rollers, wherein the one or more rolls include a plurality of transverse surface elements, which interact with discrete locations or segments along the length of the filament at regular intervals effective to impart a desired shape at those segments that is different from the original filamentary cross-sectional geometry. Further, the surface elements are typically at least partially embedded within the face of the one or more Godet-type rollers and partially protruding from the face of the rollers. Further still, the transverse surface elements may be of one or more regular or irregular geometries, including, but not limited to circular, elliptical, cubical, triangular, and combinations thereof. Optionally, the transverse surface elements may be heated to affect the polymeric continuous filament. Depending on the desired length of the resultant reinforcement fiber and the need for one or more profiled terminal fiber ends, the transverse surface elements of the one or more Godet-type rollers may be positioned in various proximities from each other within the face of the one or more rollers.

In addition, the continuous filament may be advanced onto one or more Godet-type rollers from an unwinding station containing a pre-drawn polymeric continuous filament or directly from an extrusion line, wherein the process of making the structural reinforcement fiber occurs in an in-line process. Subsequent to affecting the polymeric continuous filament with the one or more Godet-type rollers including transverse surface elements, the continuous filament may be subjected to a rewind station, or optionally advanced onto a cutting station, wherein the continuous filament is cut to a desired length and further packaged. The cutting of the shaped filament can be coordinated to provide staple or otherwise cut fibers having the profiled segments at a predetermined location(s) along the length of the cut fiber, such as at one or both terminal ends of each cut fiber.

It is also within the purview of the present invention, to advance the continuous filament on to a bundling station, wherein the fiber is cut to length, and two or more reinforcement fibers are aligned in a parallel relationship, bound together by a circumferential binding element, and packaged for shipping.

Thus, the present invention provides for improved fibrous structural reinforcements for castable compositions, and the reinforced cast products made therewith. In a particular embodiment, the improved fibrous structural reinforcements rely on an amorphous crystalline component and an isotactic crystalline component, and profiled terminal ends to improve flexural properties. The isotactic crystalline component provides an initial strength to the fiber and the amorphous crystalline component provides a latent strength once the fiber is subjected to tension and flexural input in the castable construct. The profiled terminal ends lock into the cured keyway in the castable construct, thereby providing further enhancement to the tensile strength.

### BRIEF DESCRIPTION OF THE DRAWINGS

FIG. 1 is a diagrammatic view illustrating a composite reinforcement fiber having amorphous and isotactic crystalline components, respectively, according to an embodiment of the present invention.

FIG. 2 is a diagrammatic view of a castable structure including composite reinforcement fibers according to an embodiment of the present invention under a given load of strain.

FIG. 3 is a diagrammatic view of a castable structure including composite reinforcement fibers according to an embodiment of the present invention in which the dynamic performance of the reinforcement fiber is illustrated upon initial crack formation of a castable structure under a continuous load of strain.

FIG. 4 is a diagrammatic view of a castable structure including composite reinforcement fibers according to an embodiment of the present invention in which the dynamic performance of the reinforcement fiber is illustrated upon initial crack formation of a castable structure under a continuous load of strain.

FIGS. 5A-5C are top, side and end views of a composite reinforcement fiber according to an embodiment of the present invention, in which the shank portion is generally ribbon shaped and includes the isotactic region.

FIGS. 6A-6C are top, side and end views of a composite reinforcement fiber according to an embodiment of the present invention, in which the shank portion is generally ribbon shaped and includes both an isotactic region and an amorphous region.

FIGS. 7A-7C are top, side and end views of a composite reinforcement fiber according to an embodiment of the present invention, in which the shank portion is generally round shaped and includes the isotactic region.

FIGS. 8A-8C are top, side and end views of a composite reinforcement fiber according to an embodiment of the present invention, in which the shank portion is generally round shaped and includes both the isotactic region and an amorphous region.

FIGS. 9A-9E are top view schematic illustrations of a suitable process for making composite reinforcement fibers in accordance with an embodiment of the present invention.

FIG. 10 is an alternate schematic view of a suitable process for making composite reinforcement fibers in accordance with an embodiment of the present invention.

Similarly numbered elements in the various figures represent similar features unless indicated otherwise.

### DETAILED DESCRIPTION

While the present invention is susceptible of embodiment in various forms, there is shown in the drawings, and will hereinafter be described, a presently preferred embodiment, with the understanding that the present disclosure is to be considered as an exemplification of the invention, and is not intended to limit the invention to the specific embodiment illustrated.

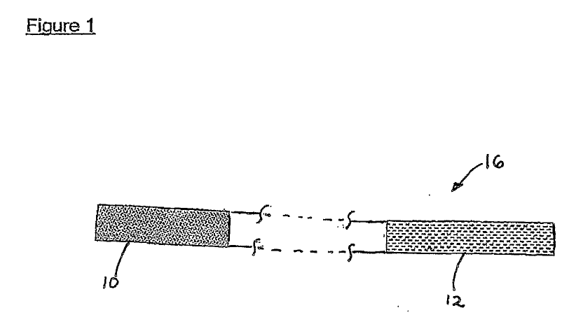

Referring to the figures, diagrammatic views are provided illustrating the components or regions of composite structural reinforcement fibers of several embodiments of the present invention. FIG. 1 is a diagrammatic view illustrating a composite reinforcement fiber 16 having an amorphous crystalline component 10 and an isotactic crystalline component 12. The components are included in the reinforcement fiber of the present invention in order to improve upon the fiber's flexural strength. Amorphous crystalline component 10 may be an entirely non-crystalline or only slightly partially crystalline component, as defined in more detail below, and isotactic crystalline component 12 may be a fully or essentially fully aligned crystalline component, as defined in more detail below. The reinforcement fibers, which include the dual morphology components, enhance the integrity of a concrete structure by bridging together micro-fissures that form when a concrete structure is compromised due to exposure to continual stress.

For purposes of the present invention, an isotactic crystalline polymer has a crystallinity percentage (%) greater than approximately 50%, particularly between 50% and 100%, and more particularly between 90% and 100%. This crystallinity percentage represents, for a temperature above 140° C., a fusion energy of between 40 J/g and 138 J/g, as described by Kenji Kamide and Keiko Yamaguchi in “Die Makromolekulare Chemie” (1972) Volume 162, page 222. The crystallinity percentage is determined, for purposes of the present application, by the use of a differential calorimetric method referred to herein as the DSC method (“Differential Scanning Calorimetry method”). This method of determining the crystallinity percentage will be referred to as the DSC method throughout this present application. The DSC method may be implemented on standard instruments available for taking such measurements, such as, e.g., a DSC 20 apparatus available from Mettler-Toledo, which can be used to measure the fusion energy of each polymer and to determine the index by comparison with the value of 138 J/g, which corresponds to an index of 100%.

For purposes herein, the term “amorphous crystalline” generally refers to polymeric material that is at least substantially amorphous. “Substantially amorphous” means polymers or copolymers having a crystallinity percentage of less than about 5%; 0 to ≈5% crystallinity, as measured by the aforementioned DSC method. “Essentially amorphous” means polymers or copolymers having a crystallinity percentage of less than 1%; i.e., 0 to 1% crystallinity, as measured by the DSC method. Therefore, unless indicated otherwise, the amorphous fiber components may be entirely non-crystalline, or alternatively may closely approximate that condition while possessing a small amount of crystallinity, as defined above.

The amorphous and isotactic fiber components, as applicable, of embodiments of the present invention may be formed from any suitable thermoplastic material. In a particular embodiment, the thermoplastic material comprises olefinic material(s). For example, the fiber components, inclusive of the isotactic, amorphous or other components thereof, may be formed from polypropylene, polyethylene, and/or blends, copolymers, derivatives thereof and the like. In one embodiment, amorphous and isotactic polypropylene components are provided in the same reinforcement fiber as made according to an embodiment of the present invention.

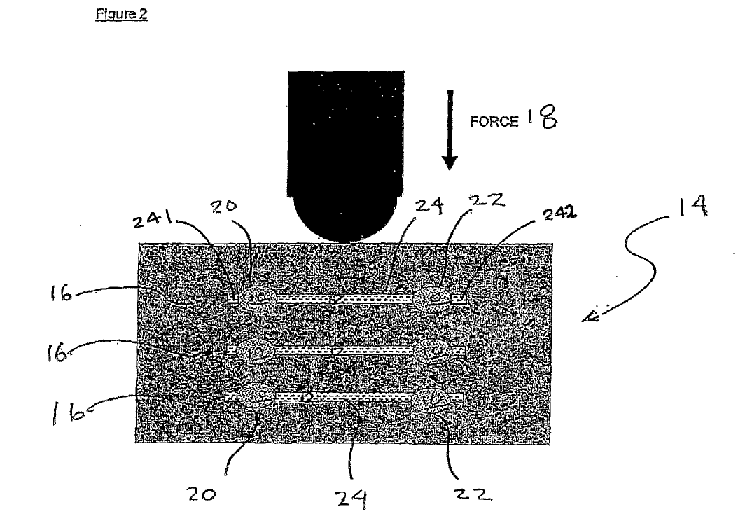

FIG. 2 is an illustrative representation of a concrete structure 14 including a plurality of discrete composite reinforcement fibers 16 of the present invention under a given strain 18. Further, FIG. 2 provides an illustrative embodiment of the reinforcement fibers 16, wherein the fibers include a first profiled terminal end 20, a second profiled terminal end 22, and a shank portion 24. In addition, the reinforcement fibers 16, which are embedded within the cured concrete structure 14, exhibit an amorphous crystalline structure 10 incorporated into the first and second profiled terminal ends 20 and 22 and an isotactic crystalline structure 12 incorporated in the shank portion 24.

The profiled terminal ends may have the same general cross-sectional geometry as the shank cross-sectional geometry; for example, both may exhibit a generally round cross-sectional geometry. Alternatively, and as illustrated in FIG. 2, the cross-sectional geometry of the profiled terminal end may differ from the cross-sectional geometry of the shank. Typically, the cross-sectional geometry of the profiled terminal ends will exhibit at least a 20% “deflection” or shift from the profile of the shank, which can be measured as deviation from diameters taken at 90 degree angles in the cross sectional profile. Additionally, typically, the profiled terminal ends will exhibit at least a 20% higher coefficient of friction than the shank portion. The coefficient of friction is measured by a pullout test in concrete, in which the test fiber is cured in a cementitious material with 50% of the fiber length embedded in the concrete matrix and the remaining 50% extends outside the concrete matrix as a loose exposed end, and then locking the concrete matrix into a vise and the loose end of the fiber into the jaws of an Instron instrument, which applies a controlled pulling force on the loose end of the fiber.

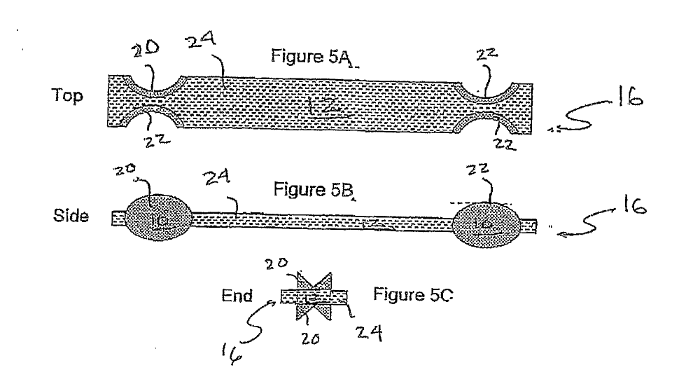

In the illustrated embodiment of FIG. 2, the shank portion extends beyond the profiled terminal ends. That is, the shank portion 24 extends between the terminal ends 20 and 22, and, in this illustration, also slightly outside them as opposite free ends 241 and 242 of the fiber structure. As can be seen in FIG. 5A, for example, and which is discussed below in more detail, the shank 24 can extend from one terminal end of the fiber 16 to the opposite terminal end thereof. However, in an alternative embodiment, the fiber 16 can be produced having the profiled terminal end(s) 20 and 22 as its most distal portion(s) of the fiber construct (i.e., the shank does not include a portion extending beyond the profiled terminal end).

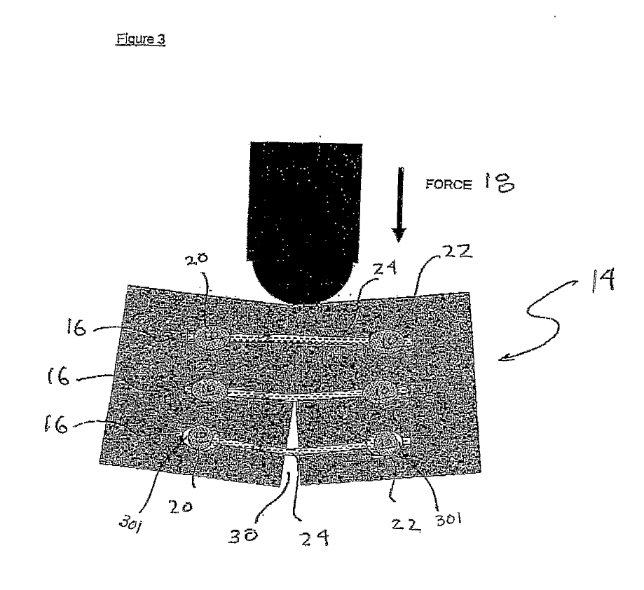

As the strain on a concrete structure 14 continues to increase and micro-fissures 30 are formed, as further illustrated in FIG. 3, the amorphous 10 and isotactic 12 components and the profiled terminal ends 20, 22 of the reinforcement fibers 16 improve the strain/stress response time or increase the amount of time that passes before the reinforcement fiber is negatively affected by the stress placed upon the concrete structure. In one embodiment, and as further illustrated in FIG. 3, the isotactic crystalline component 12 which extends the entire length of the reinforcement fiber 16, acts to capture the initial loading of strain imparted to the concrete structure. The amorphous crystalline component 10 may extend the entire length of the reinforcement fiber 16 as well to act as a malleable profile to the isotactic crystalline component 12. Alternatively, the amorphous crystalline component 10 may be solely incorporated into either or both of the profiled terminal ends 20 and 22, as illustrated in FIG. 3. Alternately, the amorphous crystalline component may be incorporated in both of the profiled terminal ends and extend the complete length of the reinforcement fiber. For example, the amorphous and isotactic crystalline components can be co-formed along the shank portions 24 of fibers 16, such as by co-extrusion of them as a bicomponent sheath-core, side-by side, or islands-in-the-sea type fiber arrangements, and so forth.

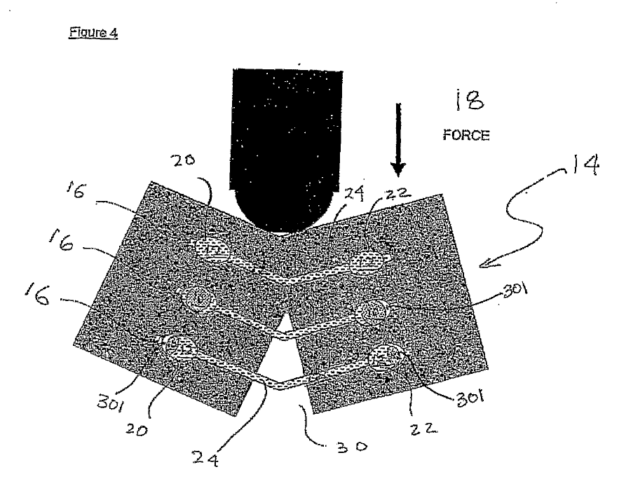

As illustrated in FIGS. 3 and 4, the malleable portion of the fiber 16 can dynamically conform to the keyway 301, and as continued force is applied, the reinforcement fibers 16 undergo in situ drawing, in addition to alignment of the amorphous crystalline component 10 within the profiled terminal ends 20 and 22 of the fiber 16.

FIGS. 5-8 illustrate other various embodiments of reinforcement fibers 16 of the present invention, wherein the profiled terminal ends 20 and 22 may be of various geometries and the shank portion 24 of the fiber may be of various constructs, including but not limited to ribbons and tapes. Further, the reinforcement fiber may include various cross-sections, wherein the ribbon, tape, or filament may be a mono-component fiber, multi-component fiber, or copolymer.

More particularly, in the embodiment illustrated in FIGS. 5A-C, the shank portion 24 of fiber 16 provides for the isotactic crystalline region 12 and the profiled terminal ends 20 and 22 provide for the amorphous crystalline region 10. The shank portion is generally ribbon shaped, or rectangular in shape. The profiled terminal ends have a generally oval side-view (FIG. 5B) shape. As shown in the top view of FIG. 5A, the profiled terminal ends form a concave arc within the shank portion. The end view of FIG. 5C depicts a wedge shaped, butterfly-like configuration of the profiled terminal ends.

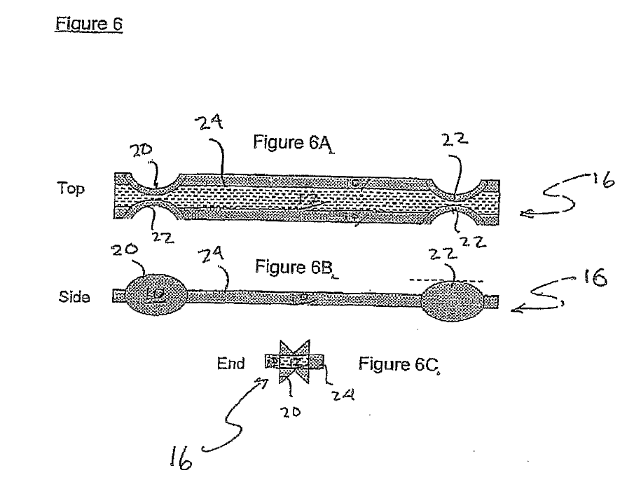

In the embodiment illustrated in FIGS. 6A-C, the shank portion 24 of fiber 16 provides for both an isotactic crystalline region 12 and an amorphous crystalline region 10. The shank portion is generally ribbon shaped, or rectangular in shape, having an isotactic core region that is surrounded on both width sides of the geometry by amorphous crystalline regions. The profiled terminal ends, which are amorphous crystalline regions, have a similar geometry to that which is shown in FIGS. 5A-C.

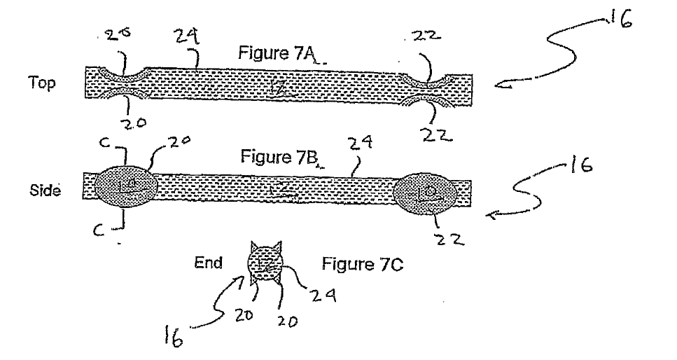

In the embodiment illustrated in FIGS. 7A-C, the shank portion 24 of fiber 16 provides for the isotactic crystalline region 12 and the profiled terminal ends 20 and 22 provide for the amorphous crystalline region 10. The shank portion is generally round in shape. The profiled terminal ends are similar in shape to those which are shown in FIGS. 5A-C.

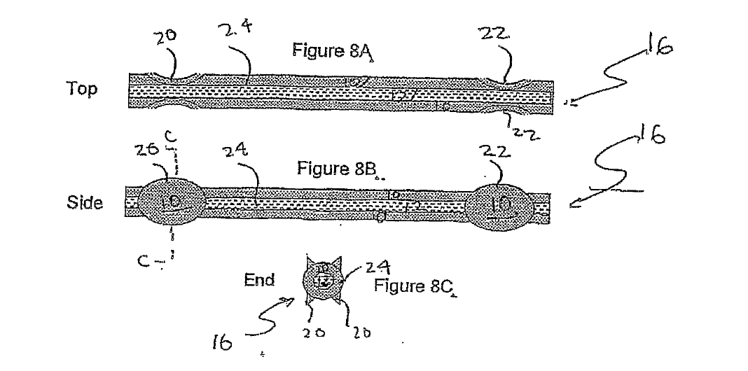

In the embodiment illustrated in FIGS. 8A-C, the shank portion 24 of fiber 16 provides for both an isotactic region 12 and an amorphous crystalline region 10. The shank portion is generally round shaped having an isotactic inner core region that is surrounded by an outer amorphous crystalline region. The profiled terminal ends, which are amorphous crystalline regions, have a similar geometry to that which is shown in FIGS. 5A-C.

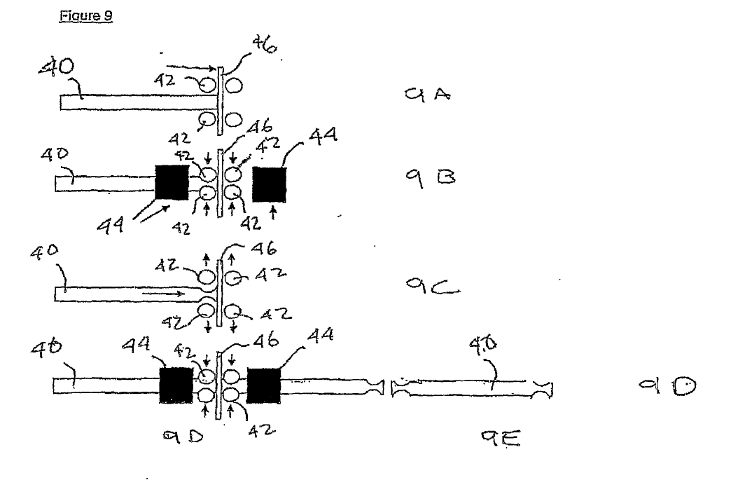

The present invention further contemplates a process for making composite structural reinforcement fiber with profiled terminal ends exhibiting improved flexural resistance. FIGS. 9A-E illustrate, from a top view perspective, one embodiment of a process for making such a composite structural reinforcement fiber. In FIG. 9A, a pre-drawn polymeric continuous filament 40 (or ribbon, tape, etc.), including at least one amorphous crystalline component (not shown) and at least one isotactic crystalline component (not shown), is unwound from an unwind station (not shown) and advanced between at least a first pair of compression elements 42. To simplify this illustration, the manner of forming the amorphous and isotactic crystalline components in the filament 40 have not been illustrated, but it will be appreciated that they can be provided in manners such as the following. In one embodiment, a process for producing such a composite fiber that jointly provides isotactic and amorphous crystalline components or regions basically involves the differential treatment of the component materials. In a particular embodiment, one means of production of such a fiber would be to produce an isotactic (e.g., greater than 50%, preferably greater than 60%, crystallinity) “starter” filament that then receives a “coating” of amorphous resin, wherein this two region filament is subsequently drawn to attain the final relative crystalline levels specified. In an alternative embodiment, a homogenous “starter” filament can be produced at a greater than 50%, or preferably greater than 60%, crystallinity, for example, wherein the outer regions of the fiber are subjected to thermal energy so as to selectively reduce the level of crystalline alignment at those locations relative to other fiber locations not subjected to the thermal energy.

As shown, in FIG. 9B, the compression elements 42, which are reciprocally movable towards and away from opposite sides of a given region of the filament 40, compress the first terminal end to impart a first desired profile to the continuous filament. In the illustrated embodiment the round shape of the compression elements will impart a terminal profile similar to those shown in FIGS. 5-8. Other shapes of the compression element are also contemplated, including but not limited to, elliptical, cubical, triangular, and combinations thereof. The release of the compression elements 42, result in a first profiled terminal end, such as shown in FIG. 9C. The pre-drawn continuous filament is subsequently advanced via control of more or more devices 44, such as, e.g., synchronized retaining feet or other suitable filament advancement means known in the fiber industry. The filament will advance under the cutting mechanism 46 and, subsequently, as shown in FIG. 9D, the compression elements will be engaged to form the second profiled terminal end. Once both profiled terminal ends have been formed, the cutting mechanism 46 will be engaged to cut the pre-drawn continuous filament to size. An example of the cut and terminal profiled, pre-drawn continuous filament 40 is shown in FIG. 9E.

According to the principles of the present invention, the process for making the structural reinforcement fiber may include two or more pair of compression elements 42 for imparting a desired profile to at least a first terminal fiber end 20, and more preferably for imparting a desired profile to the first and second terminal fiber ends, respectively 20 and 22. In addition, the two or more compression elements 42 may be heated so as to simultaneously thermally soften and shape at least the first terminal end 20 of the polymeric reinforcement filament 40.

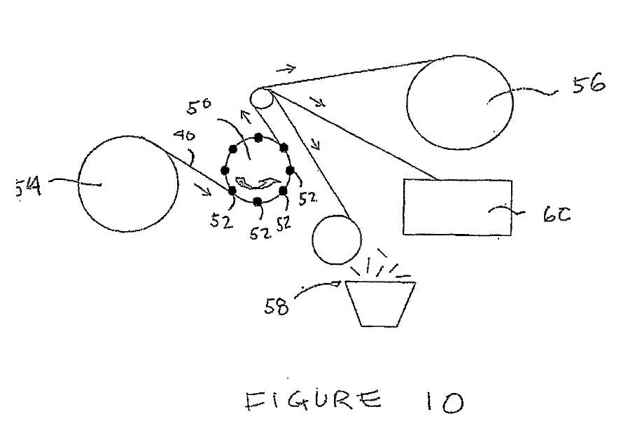

FIG. 10 is an alternate embodiment for making a structural reinforcement fiber in accordance with the present invention, wherein the process may include the use of one or more Godet-type rollers 50 having a plurality of transverse surface elements 52. The continuous filament 40 may be advanced onto one or more Godet-type rollers 50 from an unwinding station 54 containing a pre-drawn polymeric continuous filament or directly from an extrusion line (not shown), wherein the process of making the structural reinforcement fiber occurs in an in-line process.

As the continuous filament 40 is advanced onto the one or more Godet-type rollers 50, the filament 40 is affected by at least one surface element 52, and typically affected by a plurality of surface elements 52. In one embodiment, and as further illustrated in FIG. 10, the surface elements 52 of the Godet-type roller 50 are at least partially embedded within the face of the one or more Godet-type rollers 50 and partially protruding from the face of the rollers 50. Further, the transverse surface elements 52 may be of one or more regular or irregular geometries, including, but not limited to circular, elliptical, cubical, triangular, and combinations thereof. Further still, the transverse surface elements 52 may be heated to affect the profiled terminal ends of the continuous filament 40. Depending on the desired length of the resultant reinforcement fiber and the need for one or more profiled terminal fiber ends, the transverse surface elements of the one or more Godet-type rollers 50 may be positioned in various proximities from each other within the face of the one or more rollers.

As illustrated in FIG. 10, subsequent to affecting the polymeric continuous filament 40 with the one or more Godet-type rollers 50 including transverse surface elements 52, the continuous filament 40 may be subjected to a rewind station 56, or optionally advanced onto a cutting station 58, wherein the continuous filament 40 is cut to a desired length and further packaged. It is also within the purview of the present invention, to advance the continuous filament 40 on to a bundling station 60, wherein the fiber is cut to length and two or more reinforcement fibers are aligned in a parallel relationship, bound together by a circumferential binding element, and packaged for shipping. Upon formation of the cut composite fibers, the fibers also can be readily packaged through an automatic packaging system or containerized in bulk. The latter packaging allows for a defined quantity of cut fibers to be accurately and reproducibly augured, scooped or blended into a cementitious mixture at mixing station, through an automated gravimetric dispensing system.

Suitable reinforcement fiber bundling techniques are disclosed, e.g., in commonly assigned United States published application no, 2004/0244653, entitled, “Unitized fibrous concrete reinforcement”, published Dec. 9, 2004, United States published application no. 2005/0011417, entitled, “Unitized filamentary concrete reinforcement having circumferential binding element”, published Jan. 20, 2005, and United States published application no. 2005/0013981, entitled, “Unitized structural reinforcement construct”, published Jan. 20, 2005, all in the name of inventors Schmidt, et al., all of which are hereby incorporated by reference.

The dimensions of the composite fibers is defined in terms of; the overall circumference, as based on the quantity and relative denier of the individual reinforcing fibrous components, and of length, as based on the greatest finite staple length of the cumulative combination of reinforcing fibrous components. Suitable overall circumferences and lengths of unitized fibrous constructs formed in accordance with the present invention may reasonably range from 3 mm to 150 mm and from 8 mm to 100 mm, respectively. In a particular embodiment for standard concrete reinforcement practices, fibers exhibit an overall diameter of between 3 mm and 30 mm and lengths of between 12 mm and 50 mm may be utilized.

It should be noted that the composite reinforcing fibrous components optionally can be treated with performance modifying additives, such as represented by the topical application of a material flow-enhancing lubricant and temporary binding agents, such as water-soluble chemistries. The interlocking of the reinforcing fibrous components embodying the present invention can also be by chemical and/or mechanical means forms the unitized fibrous construct. Such suitable means include the application of a binder that exhibits sufficient durability to maintain the plural parallel form, and yet is discernable or otherwise deficient in durability when subjected to an appropriate external force. Preferably, the chemical and/or mechanical interlocking means comprises no more than 80% of the total surface area of the unitized fibrous construct; more preferably comprises no more than 50% of the total surface area of the unitized fibrous construct; and most preferably comprises no more than 30% of the total surface area of the unitized fibrous construct. Limiting the chemical and/or mechanical interlocking means serves to expose the significant and useful proportion of the oriented reinforcing fibrous components within the unitized fibrous constructs to the external environment. In addition, the exposure of the fibrous components allows for more effective disruption of the unified fibrous construct when subjected to mechanical or solvent disruption. Once formed, an interlocking means or agent, such as a polyvinyl alcohol or other water-soluble binding agent aids in maintaining the integrity of the fibers, and the reinforcing fibrous component therein, for purposes of shipment, measurement, and dosing into a cementitious mixture. Upon mechanical agitation, and optionally exposure to appropriate solvents, of the fibers in a cementitious mixture, the interlocked structure is disrupted, allowing for the homogenous release, distribution and dispersion of the reinforcing fibrous component into the overall cementitious mixture.

Improved hydratable cementitious compositions and fiber-reinforced concrete building products incorporating the composite fiber materials are also provided within additional embodiments of the invention. For example, the composite fibers made according to embodiments described above can be used in preparing a concrete mix that is formed and cured to provide an improved fiber-reinforced concrete building product. The cement mix can include portland cement and/or other hydratable cementitious material. It may be in dry or wet forms. The composite fiber material of embodiments of the present invention can be separately packaged, such as in concrete degradable bags, for introduction into a concrete mix at any time before, during or after concrete mixing. The synthetic fiber material can be introduced into and dispersed with ready mixed concrete, such as by using conventional concrete mix agitating or stirring means and methods before the mix sets and hardens. Alternatively, the composite fiber material can be pre-packaged as a mixture with one or more other concrete mix components, such as Portland cement and the like and/or other concrete ingredients, such as, e.g., supplementary cementitious materials (e.g., fly ash, slag, etc.), aggregates (e.g., sand, gravel, crushed stone, etc.), and/or conventional chemical admixtures used for concrete (e.g., air-entraining admixtures, accelerating admixtures, corrosion inhibitors, etc.). Concrete products of embodiments of the present invention generally may be a mixture of aggregates, paste and the synthetic fiber material. The paste, typically comprised of cement and water, binds the aggregates (usually sand and gravel or crushed stone) into a rocklike mass as the paste hardens because of the chemical reaction of the cement and water. Supplementary cementitious materials and chemical admixtures may also be included in the paste. The composite fiber material of the present invention can be dosed in concrete, e.g., at rates of at least about 0.1% by volume and up, although the preferred amount may vary depending on the particular application. The composite fiber materials particularly may be used in precast and slab on ground. Among other improvements, the concrete building product has improved micro-crack control (against propagation) while maintaining good conformability and strength contribution from the composite fiber material of embodiments herein.

Thus, the present invention provides for improved fibrous structural reinforcements for castable compositions, and the reinforced cast products made therewith. The improved fibrous structural reinforcements rely on an amorphous crystalline component an isotactic crystalline component and profiled terminal ends to improve flexural properties. The isotactic crystalline component provides an initial strength to the fiber and the amorphous crystalline component provides a latent strength once the fiber is subjected to tension and flexural input in the castable construct. The profiled terminal ends lock into the cured keyway in the castable construct, thereby providing further enhancement to the tensile strength.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. A composite structural reinforcement fiber for providing reinforcement to a castable construct, comprising a polymeric isotactic crystalline region, and a polymeric amorphous crystalline region adapted to transform to isotactic crystalline morphology in response to input forces applied thereto via the castable construct.

2. A composite structural reinforcement fiber for providing reinforcement to a castable construct, the fiber comprising:
a shank portion having a polymeric isotactic region; and
profiled terminal ends at opposite ends of the shank portion having an amorphous crystalline region.

3. The fiber of claim 2, wherein the polymeric isotactic crystalline region of the shank portion extends throughout a lengthwise direction of the shank portion.

4. The fiber of claim 2, wherein the shank portion further comprises an amorphous crystalline region.

5. The fiber of claim 4, wherein the amorphous crystalline region of the shank portion extends throughout a lengthwise direction of the shank portion.

6. The fiber of claim 2, wherein the profiled terminal ends have at least a twenty percent greater cross-sectional area than a cross-sectional area of the shank portion.

7. The fiber of claim 2, wherein the profiled terminal ends and the shank portion have generally equivalent cross-sectional geometries.

8. The fiber of claim 2, wherein the profiled terminal ends and the shank portion have generally non-equivalent cross-sectional geometries.

9. The fiber of claim 2, wherein the profiled terminal ends exhibit at least a 20 percent higher coefficient of friction than the shank portion.

10. A structural reinforcement fiber for providing reinforcement to a castable construct, the fiber comprising:
a shank portion having a first strength component; and
profiled terminal ends at opposite ends of the shank portion having a second strength component,
wherein the first strength component imparts initial strength to the fiber and the second strength component imparts latent strength to the fiber upon a predetermined flexural load being subjected to the castable construct.

11. The fiber of claim 10, wherein the first strength component of the shank portion extends throughout a lengthwise direction of the shank portion.

12. The fiber of claim 10, wherein the shank portion further comprises the second strength component.

13. The fiber of claim 10, wherein the second strength component of the shank portion extends throughout a lengthwise direction of the shank portion.

14. The fiber of claim 10, wherein the profiled terminal ends have at least a 20 percent greater deflection from a profile of the shank, measured as deviation from diameters taken at 90 degree angles in the cross sectional profile.

15. The fiber of claim 10, wherein the profiled terminal ends and the shank portion have generally equivalent cross-sectional geometries.

16. The fiber of claim 10, wherein the profiled terminal ends and the shank portion have generally non-equivalent cross-sectional geometries.

17. The fiber of claim 10, wherein the profiled terminal ends exhibit at least a 20 percent higher coefficient of friction than the shank portion.

18. A cementitious composition containing a hydratable cementitious material and a composite structural reinforcement fiber synthetic fiber material according to claim 1.

19. A cementitious composition containing a hydratable cementitious material and a composite structural reinforcement fiber synthetic fiber material according to claim 2.

20. A fiber reinforced concrete product containing a matrix comprising the cured product of a mixture including hydratable cementitious material and moisture, and a composite structural reinforcement fiber synthetic fiber material according to claim 1.

21. A fiber reinforced concrete product containing a matrix comprising the cured product of a mixture including hydratable cementitious material and moisture, and a composite structural reinforcement fiber synthetic fiber material according to claim 1.

22. A method for making structural reinforcement fiber with profiled terminal ends, the method comprising the steps of:
providing a pre-drawn polymeric continuous filament, wherein the filament includes an amorphous crystalline component and an isotactic crystalline component;
advancing the continuous filament between a first pair of compression elements;
compressing the continuous filament between the first pair of compression elements to form a first profiled terminal end;
advancing the continuous filament between a second pair of compression elements;
compressing the continuous filament between the second pair of compression elements to form a second profiled terminal end;
advancing the continuous filament through a cutting mechanism; and
cutting the continuous filament to size.

23. The method of claim 22, further comprising the step of pre-drawing the polymeric continuous filament from an extrusion line and unwinding the polymeric continuous filament from an unwinding station.

24. The method of claim 22, wherein the steps compressing the continuous filament between the first and second pairs of compression elements to form a first and second profiled terminal ends further comprise compressing the continuous filament between the first and second pairs of heated compression elements to form a first and second profiled terminal ends.

25. The method of claim 22, wherein said providing of the pre-drawn polymeric continuous filament including an amorphous crystalline component and an isotactic crystalline component comprises the steps of providing an isotactic crystalline substrate filament comprising at least 50 percent crystallinity, applying a coating of amorphous resin to said substrate filament, drawing the resulting two region filament effective to attain an amorphous crystalline coating on an isotactic crystalline substrate.

26. The method of claim 22, wherein said providing of the pre-drawn polymeric continuous filament including an amorphous crystalline component and an isotactic crystalline component comprises the steps of providing a homogenous substrate filament having greater than 50 percent crystallinity, and subjecting outer regions of the substrate fiber to thermal energy effective to selectively reduce the level of crystalline alignment at those fiber locations relative to other fiber locations not subjected to the thermal energy.

27. A method for making structural reinforcement fiber with profiled terminal ends, the method comprising the steps of:
providing a polymeric continuous filament, wherein the continuous filament includes at least a first amorphous crystalline component and at least a first isotactic crystalline component;
advancing the continuous filament onto a first Godet-type roll, wherein the roll includes at least one transverse surface element for modifying the profile of the continuous filament;
advancing the continuous filament through a cutting mechanism; and
cutting the continuous filament to size.

28. (canceled)
